(19) United States
(12) Patent Application Publication
(10) Pub. No.: US 2015/0129073 A1
(43) Pub. Date: May 14, 2015

(54) Quick-release end cap with identification card

(71) Applicant: Norman Quagliani, Warren, MI (US)

(72) Inventor: Norman Quagliani, Warren, MI (US)

(21) Appl. No.: 13/998,570

(22) Filed: Nov. 12, 2013

(51) Int. Cl. F16L 55/11; F17D 5/02

(52) U.S. Cl. CPC F16L 55/1141; F17D 5/02; F16L 2201/60
USPC 138/89; 138/104; 138/96 R

(57) ABSTRACT

The disclosure relates to a quick release end cap device for manually attaching to, or removal from, a hose line, pipeline or pipeline termination bank. The quick release end cap device is useful to identify the contents of the hose line, pipeline, or pipeline termination bank. The end cap device is interchangeable among and between hoses, pipelines and pipeline termination banks. The end cap is further advantageous in that it does not require any tools and is designed to capture drips when the quick release end cap is attached to the pipeline, hose line, or pipeline termination bank. The end cap device comprises a generally cylindrical housing, a cavity area on the housing designed for insertion of an interchangeable identification card, and a recess within the housing to engage a drip pad. The housing includes at least one flexible locking tab to facilitate the quick release feature of the end cap device. The identification card is reusable and adaptable to visually display identification information about a pipeline, hose line, or pipeline termination bank when the quick release end cap is applied to the termination end of a hose line, pipeline, or pipeline termination bank.

### TECHNICAL FIELD

This disclosure relates generally to certain pipe, pipeline and hose termination fittings known as dust caps or end caps used in hose lines, pipelines, and pipeline termination racks. More specifically, this disclosure relates to an end cap that can be utilized for the immediate, visual identification of the contents of the pipeline or hose system when connecting or disconnecting from, or to, that pipeline system.

### BACKGROUND

The function of an end cap is to close off the end of a line in a piping system or an industrial hose. This is achieved by placing the end cap over the open line or hose end. End caps are designed to prevent leakage or drips of liquids from the end of the hose or pipe. End caps are typically used in conventional pipe equipment in the chemical industry, the petroleum industry, the marine industry, irrigation systems, water treatment works, sanitary systems, and power generation facilities.

A wide variety of pipe end caps have been developed in the art. End caps may include welded fittings, screw-type fittings, cam and groove lock- type fittings, and quick release fittings. Quick release type pipe fittings are designed to quickly and easily connect pipelines or any other line with a complementary end connection. Quick release or quick connect end caps and dust caps are not used in pressure applications for safety and environmental reasons.

All pipe and hose end caps are designed to prevent fluid leakage, primarily liquids, from dripping to the ground or floor. To prevent leakage or capture drips, the end points of pipelines and the hose lines must be capped or sealed. Several methods have been developed to prevent leakage at the end of pipes and hose line terminations. Some end caps require tools to complete the closure. For example, U.S. Pat. No. 3,713,463 to Bywater, Jr. discloses a closure member for pipes and the like. The Bywater, Jr. patent requires tools to operate a latching mechanism on the closure member. Also, U.S. Pat. No. 4,205,707 to Lundgren discloses a pipe protector that covers a pipe end. Similarly, the Lundgren patent also requires the use of tools to align teeth employed in the pipe protector.

Some end caps incorporate a “quick release” feature that does not require tools to effect closure. Generally, the quick release pipe end caps have a cap that covers the end of a pipeline and a quick release mechanism that removably secures the cap to the pipeline. U.S. Pat. No. 6,568,430 issued to Shafer describes quick-release pipe end cap that does not require the use of other pipefitting tools. However, the Shafer patent employs an external latching mechanism with a band that is integral to the end cap.

End caps have also been employed simply as a protective safety cover. For example, U.S. Pat. No. 5,687,772 issued to Underwood describes a protective end cap for covering the ends of exposed bars and, in particular but not limited to, a protective end cap for covering the ends of starter bars on construction sites.

In addition to requiring either pipefitting tools or an external latching mechanism, another shortcoming identified with virtually all conventional end caps is that they do not provide a means to identify the content of the pipelines. Identification of the content of the pipelines is required for filling or removing fluids from a pipeline. It is especially critical when all the end connections are situated in a common bank of multiple pipeline terminations all fitted with end caps. Identification of the contents of the pipeline is important to prevent opening the wrong pipeline to either fill or remove liquid product from the pipeline. There have been few attempts to make the identification of the contents of a pipeline easier.

U.S. Pat. No. 7,644,734 issued to Palmer describes a male and female safety cap. The safety cap has a loop handle to protect the hands of the operator. The loop handle is formed as a continuous arcuate structure to provide protection to the operator's hand. These safety caps are color-coded or affixed with labels designed to fit within the handle structure. However, this particular end cap design requires a handle that is integral to the end cap in order to affix a label. This end cap also employs a latching mechanism

The end cap devices referenced above provide some desirable features and benefits within the limited scope of their designs. Each has certain drawbacks, as well, with respect to the fact that they require tools or external latching mechanisms, and they are not effective to identify the contents of a pipeline system or hose line.

Based on the foregoing, it is desirable to have an end cap that provides drip protection, can be easily applied without the use of tools or an external latching mechanism, and can identify hose line or pipeline system contents. This type of end cap would also be available in different sizes and different materials, thereby allowing it to be easily applied to a variety of pipeline systems, hose lines, or pipeline termination banks.

### BRIEF SUMMARY OF THE INVENTION

In view of the foregoing disadvantages inherent in the known types of end caps for pipes and the like now present in the prior art, the present invention provides an improved quick release pipe end cap, and overcomes the above-mentioned disadvantages and drawbacks of the prior art. As such, the general purpose of the present invention, which will be described subsequently in greater detail, is to provide a new and improved quick release pipe end cap which has all the advantages of the prior art mentioned heretofore and many novel features that result in a quick release pipe end cap which are not anticipated, rendered obvious, suggested, or even implied by the prior art, either alone or in any combination thereof. Heretofore, there has not been an end cap for quickly identifying the contents of a pipeline system, hose line, or multiple terminations in a bank of pipeline terminations, while at the same time protecting the pipeline system from fluid leakage and cross-contamination (i.e., contamination caused by putting a fluid into a pipeline that is incompatible with the other fluid contents contained in that pipeline).

The disclosure herein is directed to an end cap designed for quick placement or removal without the use of tools or external latching mechanisms. It is also an end cap that is useful as well for identification of the contents of hose lines or liquid transport systems while either filling or removing fluids from or to those systems. When several end connections are situated in a common bank of hose line terminations fitted with end caps, it would relatively easy to fill or empty the wrong system when there is no identification of the pipeline that the operator is connecting to for performing the fill or empty operation. There is also disclosed a unique method for providing identification of a pipeline system by applying an identification card into a an end cap that has been designed and fabricated to receive such identification card. Because the identification card is removable, the card can be removed and a new card inserted when the end cap is to be used on a different pipeline.

While the various embodiments of the disclosure are described with reference to a device for identifying the contents of a pipeline system quickly using an end cap with an identification feature, it is to be understood that there may be combinations of equipment and other methods that could be used to identify the pipeline system. There is no device or apparatus or method with the disclosed features for use in pipeline systems. Other applications and advantages of such an end cap will become immediately obvious to one skilled in the art. It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### DESCRIPTION OF THE DRAWINGS

FIG. 1 is a perspective top view of the present invention.

FIG. 2 is a top view of the present invention.

FIG. 3 is an exploded perspective bottom view of the present invention.

FIG. 3A is a side view of the drip pad disclosed in the present invention.

FIG. 4 is a bottom view of the present invention.

### DETAILED DESCRIPTION OF THE INVENTION

What is being disclosed is an end cap designed and fabricated to be manually applied without the use of tools or external latching mechanisms and to provide visual identification information of hose and pipeline system contents. Other objects, advantages and applications will be best understood and become apparent from the following description of the various embodiments when read in connection with the accompanying drawings.

Referring to FIGS. 1 to 4, the end cap 10 for a pipeline system is shown here in the preferred embodiment of the invention. The end cap 10 is designed to be manually applied and visually identify the contents of a hose, pipeline, or pipeline termination bank prior to filling or removing liquids from a hose, pipeline, or pipeline termination bank. In the preferred embodiment, the end cap 10 comprises a housing 12, which is of a generally cylindrical shape, a top surface 14, an outer lateral surface 16, an inner lateral surface 18, and an open end 20. The housing 12 is preferably comprised of any suitable plastic material and may be formed by an injection molding process.

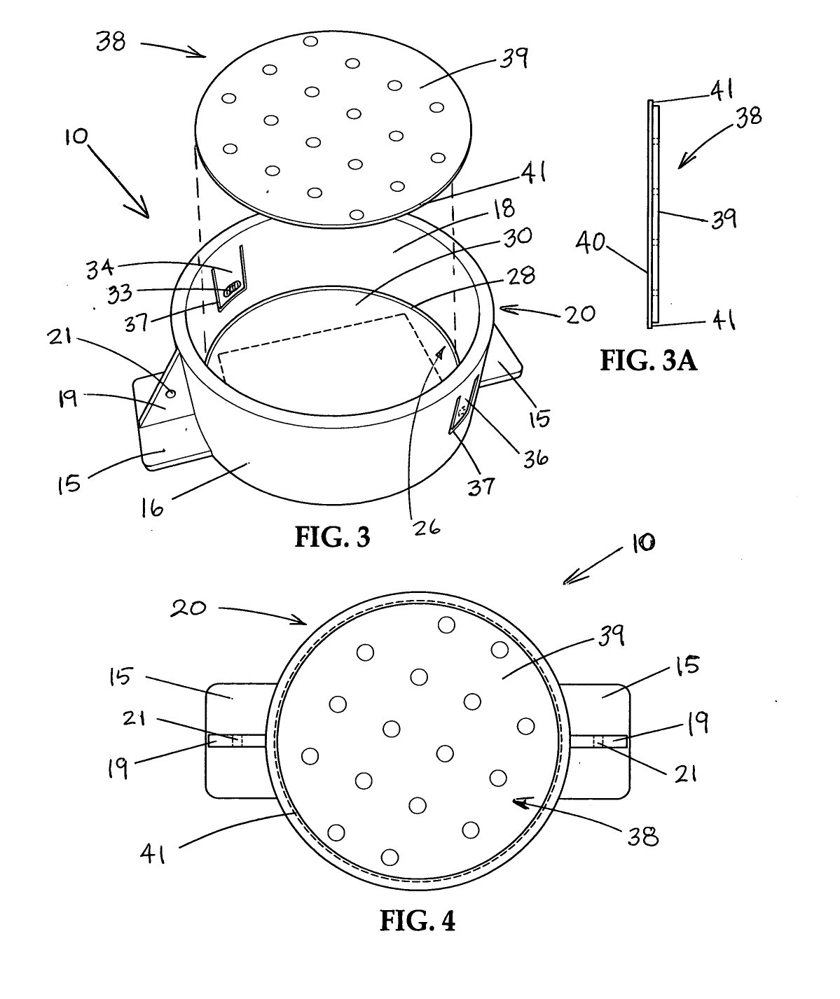

In one embodiment, the housing further comprises at least one support gusset 19 that is configured to permanently engage the outer lateral surface 16 and the at least one lateral extension 15. In the preferred embodiment shown with reference to FIGS. 1 and 3, there is shown a pair of lateral extensions 15 and support gussets 19 that are located diametrically opposite each other. The lateral extensions 15 may be used by an operator as a push/pull means to either engage or disengage, respectively, the end cap 10 to or from a hose, pipeline, or pipeline termination bank (not shown).

In the preferred embodiment shown with reference to FIGS. 1 and 3, there is shown a pair of support gussets 19 that are located diametrically opposite each other and are configured to permanently engage the outer lateral surface 16 and the at least one lateral extension 15. The support gussets 19 are generally triangular in shape but could be either square or rectangular, as well. In the preferred embodiment, the support gussets 19 also comprise a lock-ring hole 21. The lock-ring hole 21 is useful to releasably attach a lanyard, chain, rope or other similar attachment (not shown) to the end cap 10. One end of the lanyard, chain, rope or other similar attachment is attached to the end cap 10 by attaching to the lock-ring hole 21 and the other end of the lanyard, chain, rope or other similar attachment is attached to a hose, pipeline, or pipeline termination bank (not shown). This attachment arrangement between the end cap 10 and the hose, pipeline, or pipeline termination bank permits the operator to easily locate the proper end cap 10 for closing off an open end of the hose, pipeline, or pipeline termination bank, or to release the end cap 10 after it has been removed from the end of the hose, pipeline, or pipeline termination bank.

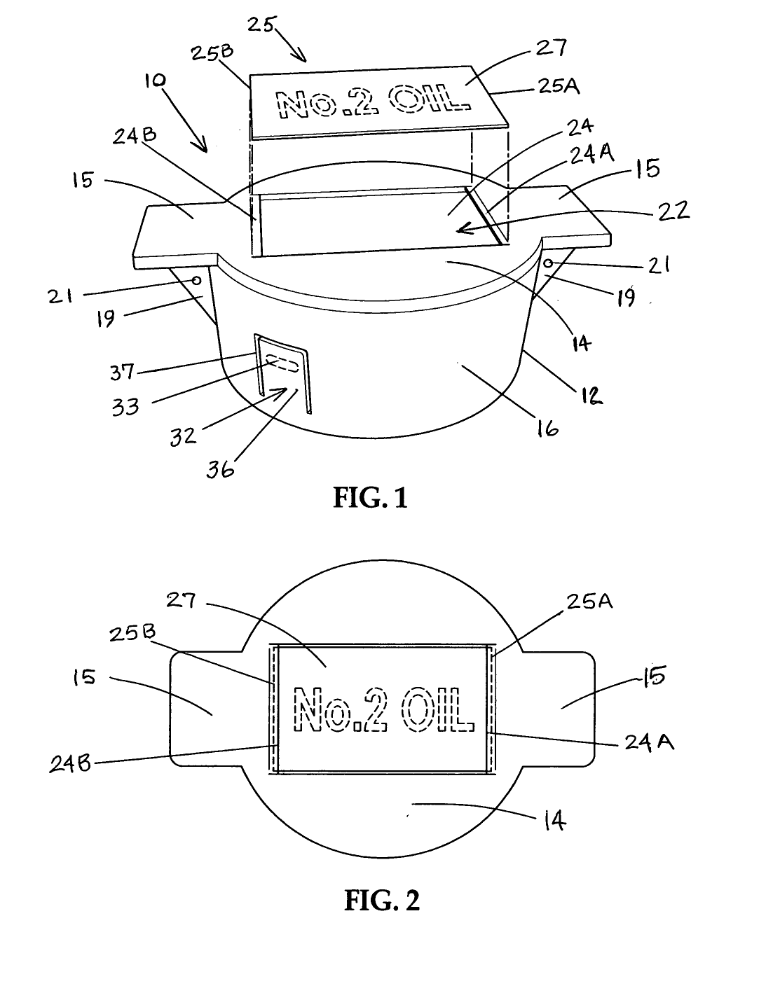

As shown in FIGS. 1 and 2, the top surface 14 includes an identification card holder 22 and a pair of lateral extensions 15. The identification card holder 22 comprises a cavity area 24 integrally formed with the top surface 14. An identification card 25, which includes an upper surface 27 and a pair of opposing sides 25A, 25B, is preferably made of a flexible material that is sized to fit into the cavity area 24 in the identification card holder 22. The identification card 25 with the pair of opposing sides 25A, 25B is inserted into the cavity area 24 beneath the at least two retaining ends 24A, 24B. The at least two retaining ends 24A, 24B require the identification card 25 to be slightly flexed in order to position the pair of opposing sides 25A, 25B between the at least two retaining ends 24A, 24B. The pair of opposing sides 25A, 25B extend under the at least two retaining ends 24A, 24B. The identification card 25 is thereby releasably attached to the top surface 14 of the housing 12. The housing 12 allows for manual application of the end cap 10 and provides for visual identification of the contents of a system prior to either filling liquids through, or removing fluids from, a system when an identification card 25 is properly inserted into the identification card holder 22 and the end cap 10 is applied to hoses, pipelines, or pipeline termination banks (not shown) connected to a pipeline system. The identification card 25 visually displays information about the contents of a pipeline system by writing content information on the upper surface 27 of the identification card 25 as shown in FIGS. 1 and 2.

The housing 12 comprises an outer lateral surface 16 and an inner lateral surface 18. In one embodiment of the invention, the housing comprises at least one flexible locking tab 32 comprising an inner face 34 located on the inner lateral surface 18 and an outer face 36 located on the outer lateral surface 16. In the preferred embodiment as shown in FIGS. 1 and 3, there is shown a pair of flexible locking tabs 32 located diametrically opposite of each other. The flexible locking tabs 32 have a generally U-shaped open spacing 37 around their perimeter. In one embodiment the at least one flexible locking tab 32 comprises at least one engaging nub 33 located on the inner face 34. In the preferred embodiment as shown in FIGS. 1 and 3, each of the flexible locking tabs 32 comprises an engaging nub 33. The flexible locking tabs 32 allow the end cap 10 to securely engage with a pipeline system when the engaging nubs 33 contact the outer diameter surface of the end of a hose, pipeline, or pipeline termination bank (not shown). When the at least one engaging nub 33 contacts the outer diameter surface of the end of a hose, pipeline, or pipeline termination bank, the flexible locking tab 32 is flexed slightly outward from the outer lateral surface 16.

With reference to FIGS. 3, 3A and 4, a perspective view of the preferred embodiment of the end cap 10 is illustrated. The inner lateral surface 34 with a pair of flexible locking tabs 32 and engaging nubs 33 on the inner face 34 are shown. The open end 20 is designed to releasably connect to a receiving end portion of a hose, pipeline, or pipeline termination bank (not shown).

Again with reference to FIGS. 3, 3A and 4, the drip pad engagement means 26 is shown comprising a circumferential lip engagement recess 28 located at a bottom surface 30 of the open end 20. To prevent drips from the end cap 10 when the end cap is engaged with the end of a hose, pipeline, or pipeline termination bank, a drip pad 38 is removably engaged with the drip pad engagement means 26. The drip pad 38 comprises a circumferential front absorbent side 39 and a circumferential back engagement side 40. The circumferential front absorbent side 39 has a slightly smaller diameter than the circumferential back engagement side 40. The difference in diameters between the diameter of the circumferential front absorbent side 39 and the slightly smaller diameter of the circumferential back engagement side 40 results in the formation of a circumferential lip 41. The circumferential lip 41 allows the drip pad to releasably engage the lip engagement recess 28. In an alternative embodiment, instead of a circumferential lip 41, the lip could be comprised of a series of spaced apart arcuate lip tabs (not shown). FIG. 4 shows the drip pad 38 completely seated within the housing 12, against the bottom surface 30, by having the circumferential lip 41 fully inserted in the lip engagement recess 28.

The foregoing descriptions provide illustration of the inventive concepts. It should be understood that the foregoing is illustrative of particular embodiments of the invention, and particular applications thereof The descriptions are not intended to be exhaustive or to limit the disclosed invention to the precise form disclosed. Modifications or variations are also possible in light of the above teachings. In view of the disclosures presented herein, yet other variations of the invention being disclosed will be apparent to one of skill in the art. The embodiments described above were chosen to provide the best application to thereby enable one of ordinary skill in the art to utilize the invention in various embodiments and with various modifications as are suited to the particular use contemplated. All such modifications and variations are within the scope of the invention. Any such modifications or variations which fall within the purview of the descriptions contained herein are intended to be included therein, as well. It is the following claims, including all equivalents, which define the scope of the invention.

What is claimed is:

1. An end cap, comprising:
a housing, the housing comprising a generally cylindrical shape and further comprising a top surface, an outer lateral surface, an inner lateral surface, and an open end;
an identification card holder, the identification card holder comprising a cavity area that is integral with the top surface and further comprising at least two retaining ends;
a drip pad engagement means, the drip pad engagement means comprising a lip engagement recess located at a bottom surface of the open end; and
at least one flexible locking tab, the at least one flexible locking tab comprising an inner face located on the inner lateral surface and an outer face located on the outer lateral surface.

2. The end cap of claim 1 further comprising an identification card, the identification card comprising an upper surface and at least two opposing sides, the identification card removably engageable with the cavity area.

3. The end cap of claim 1 wherein the at least one flexible locking tab comprises at least one engaging nub located on the inner face.

4. The end cap of claim 1 wherein the top surface of the housing comprises at least one lateral extension.

5. The end cap of claim 1 wherein the housing further comprises a generally U-shaped open spacing around the perimeter of the at least one flexible locking tab.

6. The end cap of claim 1 further comprising a drip pad, the drip pad adaptable to engage the lip engagement recess.

7. The end cap of claim 6 wherein the drip pad comprises a front absorbent side and a back engagement side, the back engagement side comprising a circumferential lip to releasably engage the lip engagement recess.

8. The end cap of claim 4 wherein the housing further comprises at least one support gusset, the at least one support gusset configured to permanently engage the outer lateral surface and the at least one lateral extension.

9. The end cap of claim 8 wherein the at least one support gusset comprises at least one lock-ring hole.

10. The end cap of claim 1 wherein the housing is comprised of any suitable plastic material.

11. An end cap, comprising:
a housing, the housing comprising a generally cylindrical shape and further comprising:
a top surface, an outer lateral surface, an inner lateral surface, and an open end;
at least one lateral extension, the at least one lateral extension located on the top surface;
at least one lateral support gusset, the at least one support gusset configured to permanently engage the outer lateral surface and the at least one lateral extension;
an identification card holder, the identification card holder comprising a cavity area located on the top surface;
a drip pad engagement means, the drip pad engagement means comprising a lip engagement recess located at a bottom surface of the open end; and
at least one flexible locking tab, the at least one flexible locking tab comprising an inner face located on the inner lateral surface and an outer face located on the outer lateral surface;
an identification card, the identification card adaptable to be removably engageable with the cavity area; and
a drip pad, the drip pad adaptable to engage the lip engagement recess.

12. A method for identifying the contents of a pipeline system utilizing a quick release end cap, the method comprising the steps of:
providing a housing having a top surface, an outer lateral surface, an inner lateral surface, an open end, an identification card holder, a drip pad engagement means, and at least one flexible locking tab;
inserting a drip pad into the drip pad engagement means;
providing an identification card comprised of a suitable flexible material and further comprising an upper surface;
providing identifying information regarding the contents of the pipeline system on the upper surface of the identification card;
inserting the identification card into the identification card holder with the upper surface facing upward;
positioning the housing with the identification card inserted into the identification card holder on an end of a pipeline system; and
applying a manual pushing pressure to engage the at least one flexible locking tab with an open end of a complementary connection on a pipeline system.

13. The method of claim 12 wherein the housing is generally cylindrical.

14. The method of claim 12 wherein the housing further comprises a drip pad removably engageable with the drip pad engagement means.

15. The method of claim 12 wherein the housing further comprises an identification card removably insertable into the identification card holder.

16. The method of claim 12 wherein the pipeline system comprises hose lines, pipe lines, and pipeline termination racks.
